(19) United States
(12) Patent Application Publication
(10) Pub. No.: US 2020/0386391 A1
(43) Pub. Date: Dec. 10, 2020

(54) SERIES-PARALLEL STRUCTURE LAMP STRING AND SYSTEM

(71) Applicant: Shangyou Jiayi Lighting Product Co., Ltd., Ganzhou (CN)

(72) Inventor: Yaowen HE, Ganzhou City (CN)

(21) Appl. No.: 16/893,554

(22) Filed: Jun. 5, 2020

(30) Foreign Application Priority Data
Jun. 6, 2019 (CN) 201920856604.4

(51) Int. Cl. F21V 23/06; F21S 4/10

(52) U.S. Cl. CPC F21V 23/06; F21S 4/10

(57) ABSTRACT

A series-parallel structure lamp string and a series-parallel structure lamp string system are provided. The series-parallel structure lamp string includes: two wires and a plurality of lamp beads, wherein the plurality of lamp beads are connected in parallel on the two wires, the two wires includes one or more single-wire gaps, and the lamp beads at two sides of each single-wire gap are connected with the two wires in such a manner that positive poles and negative poles of the lamp beads at two sides are opposite, such that connection of the lamp beads adjacent to the single-wire gap are converted from parallel connection to series connection and the two wire ends at the single-wire gap are fixed with adjacent lamp beads by glue.

### CROSS-REFERENCE TO RELATED APPLICATION

The present disclosure claims priority of Chinese Patent Application with the filing number 201920856604.4 filed on Jun. 6, 2019 with the Chinese Patent Office, and entitled “Series-parallel Structure Lamp String and System”, the contents of which are incorporated herein by reference in their entirety.

### TECHNICAL FIELD

The present disclosure relates to the technical field of lamp string structures, in particular to a series-parallel structure lamp string and a series-parallel structure lamp string system.

### BACKGROUND ART

The electrical connection structure of existing LED lamp string of copper wire is in parallel connection, and such lamp string has the defect that the lamp string cannot be too long, because brightness at the head of the lamp string will be inconsistent with brightness at the tail of the lamp string if the lamp string is too long, thus the lamp string must be in series connection if a longer lamp string is desired.

### SUMMARY

Objects of the present disclosure include providing a series-parallel structure lamp string (lamp string having a series-parallel structure) and a series-parallel structure lamp string system (lamp string system having a series-parallel structure).

An embodiment of the present disclosure provides a series-parallel structure lamp string, including: two wires and a plurality of lamp beads, wherein the plurality of lamp beads are connected in parallel on the two wires, the two wires include one or more single-wire gaps, the lamp beads at two sides of the single-wire gap are connected with the two wires in such a manner that positive poles and negative poles of lamp beads at one side are opposite to those of lamp beads at the other side, such that connections of the lamp beads adjacent to the single-wire gap are converted from parallel connection to series connection.

In the above, two wire ends at each single-wire gap are fixed with adjacent lamp beads by glue.

An embodiment of the present disclosure provides a series-parallel structure lamp string system, including the above series-parallel structure lamp string and a power supply controller which is configured to supply power to the series-parallel structure lamp string.

### BRIEF DESCRIPTION OF DRAWINGS

In order to more clearly illustrate embodiments of the present disclosure or technical solutions in the prior art, accompanying drawings which need to be used for description of the embodiments or the prior art will be introduced briefly below, and apparently, the accompanying drawings in the description below merely show some embodiments of the present disclosure, and those ordinarily skilled in the art still could obtain other relevant accompanying drawings in light of these accompanying drawings, without using creative effort.

FIG. 1 is a structural view of a series-parallel structure lamp string provided in an embodiment of the present disclosure; and

FIG. 2 is a structural view of a series-parallel structure lamp string system provided in an embodiment of the present disclosure.

### REFERENCE SIGNS

110—first wire; 120—second wire; 131—first single-wire gap; 132—second single-wire gap; 11—first lamp bead; 12—second lamp bead; 13—third lamp bead; 14—fourth lamp bead; 15—fifth lamp bead; 16—sixth lamp bead; 1101—first protection sleeve; 1201—second protection sleeve; 140—power supply controller.

### DETAILED DESCRIPTION OF EMBODIMENTS

Technical solutions of the present disclosure will be described below clearly and completely in connection with embodiments, and apparently, the embodiments described are only a part of embodiments of the present disclosure, rather than all embodiments. All other embodiments obtained by those ordinarily skilled in the art based on the embodiments of the present disclosure without using creative effort shall fall within the scope of protection of the present disclosure. It should be indicated that terms “first”, “second” and so on in the description, the claims and the accompanying drawings of the present disclosure are used for distinguishing similar objects, rather than for describing a specific order or sequence. It should be understood that the data used in this way can be interchanged under appropriate circumstances, so that the embodiments of the present disclosure described herein can be implemented in an order other than those illustrated or described herein. Besides, terms “comprise”, “have” and any derivatives thereof are intended to cover non-exclusive inclusions, for example, a process, method, system, product or device that contains a series of steps or units is not necessarily limited to those steps or units expressly listed, but may include other steps or units not expressly listed or inherent to such process, method, product or device.

Herein, it also needs to indicate one point that in order to avoid obscuring the present disclosure with unnecessary detail, only device structures closely related to the solution according to the present disclosure is shown in the accompanying drawings, and other details not closely related to the present disclosure are omitted.

The lamp bead string has quite wide application, for example, on exterior decoration of buildings, interior decoration of rooms, decoration of parks, squares and so on. At present, the circuit structure of the lamp bead string is in parallel connection or in series connection, the wire and the LED are encapsulated in encapsulant, and copper wire lamp strings are generally common. The series connection of the existing lamp string is always achieved by cutting off lamp strings in parallel connection, however, after a positive pole and a negative pole of the cut-off part are connected by electric soldering iron, there is an extra useless wire after such connection, and only one wire is stressed at the place for series connection formed by cutting off lamp strings in parallel connection, so that insufficient soldering is also easy to occur in welding, and the phenomenon of wire breakage is quite easy to appear. Meanwhile, during packaging or assembling of the finished product complete cut-off will result in easy scratching or scraping of hand or product at the place of the cut, and may also directly tear and damage the lamp beads.

On such basis, in a series-parallel structure lamp string and a series-parallel structure lamp string system provided in the embodiments of the present disclosure provided in the present disclosure, a plurality of single-wire gaps may be provided on wires, such that connections of the lamp beads adjacent to the single-wire gaps change from parallel connection to series connection, and meanwhile, two wire ends at each single-wire gap are encapsulated and fixed with the adjacent lamp beads by glue (or adhesive), such that the two wire ends at the single-wire gap are encapsulated together with the respective lamp bead, which alleviates the technical problem in the prior art that inconveniences are caused in terms of welding, assembling and so on when connections of the lamps beads change from parallel connection to series connection.

The present disclosure is described in detail below in combination with accompanying drawings.

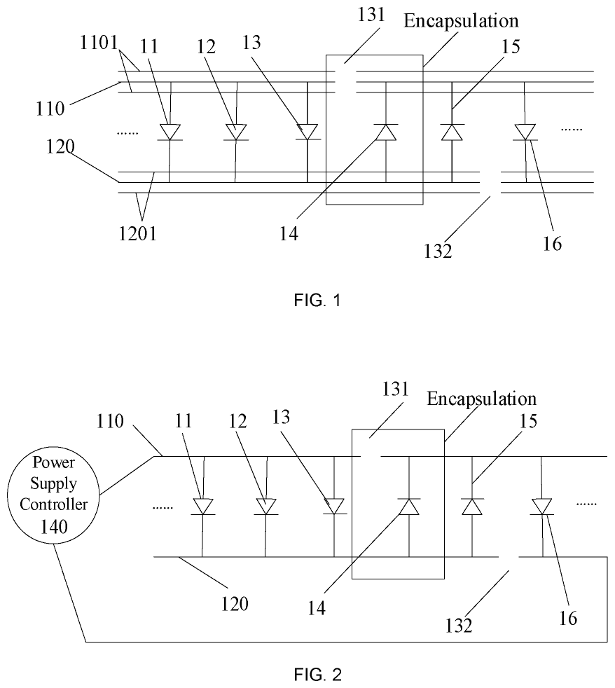

In combination with FIG. 1, an embodiment of the present disclosure provides a series-parallel structure lamp string, which can alleviate the technical problem in the prior art that inconveniences are caused in terms of welding, assembling and so on when the lamps beads change from parallel connection to series connection. The lamp string includes: two wires and a plurality of lamp beads, wherein the plurality of lamp beads are connected in parallel on the two wires, namely, a first wire 110 and a second wire 120, each of the two wires include one or more single-wire gaps, for example, in combination with FIG. 1, a first single-wire gap 131, and a second single-wire gap 132 are provided, and the lamp beads at two sides of each single-wire gap are connected with the two wires in such a manner that positive poles and negative poles of the lamp beads at two sides are opposite, such that the lamp beads adjacent to the single-wire gap are converted from parallel connection to series connection.

As shown in FIG. 1, in which six lamp beads are taken as an example, i.e., a first lamp bead 11, a second lamp bead 12, a third lamp bead 13, a fourth lamp bead 14, a fifth lamp bead 15, and a sixth lamp bead 16, wherein positive poles of the first lamp bead 11, the second lamp bead 12, and the third lamp bead 13 are all connected with the first wire 110, negative poles of the three lamp beads are all connected with the second wire 120, a positive pole of the fourth lamp bead 14 is connected with the second wire 120, a negative pole of the fourth lamp bead 14 is connected with the first wire 110, a positive pole of the fifth lamp bead 15 is connected with the second wire 120, a negative pole of the fifth lamp bead 15 is connected with the first wire 110, a positive pole of the sixth lamp bead 16 is connected with the first wire 110, and a negative pole of the sixth lamp bead 16 is connected with the second wire 120. In the above, the wire between the third lamp bead 13 and the fourth lamp bead 14 is provided with the first single-wire gap 131, therefore, the lamp beads at two sides of the first single-wire gap 131 refer to the first lamp bead 11, the second lamp bead 12, and the third lamp bead 13 at one side, and the fourth lamp bead 14 and the fifth lamp bead 15 at the other side, and it can be seen from the above introduction that the first lamp bead 11, the second lamp bead 12, the third lamp bead 13 and the fourth lamp bead 14 and the fifth lamp bead 15 are connected with the two wires in such a manner that the positive poles of and negative poles of the first lamp bead 11, the second lamp bead 12, and the third lamp bead 13 are opposite to those of the fourth lamp bead 14 and the fifth lamp bead 15. Likewise, the lamp beads at two sides of the second single-wire gap 132 refer to the fourth and fifth lamp beads at one side and the sixth lamp bead at the other side, and it can be seen from the above introduction that the fourth lamp bead 14 and the fifth lamp bead 15 and the sixth lamp bead 16 are connected with the two wires in such a manner that their positive poles and negative poles of the fourth lamp bead 14 and the fifth lamp bead 15 are opposite to those of the sixth lamp bead 16. Due to the existence of the first single-wire gap 131, the parallel connection relation between the third lamp bead 13 and the fourth lamp bead 14 becomes series connection, and likewise, due to the existence of the second single-wire gap 132, the parallel connection relation between the fifth lamp bead 15 and the sixth lamp bead 16 becomes series connection.

When DC control is performed on the lamp string, a DC high voltage may be applied to the first wire 110, so that the first lamp bead 11, the second lamp bead 12, and the third lamp bead 13 are in parallel connection and turned on, when the current passes through the third lamp bead 13, and flows from the positive pole of the third lamp bead 13 to the second wire 120 through the negative pole of the third lamp bead 13, as a part between the third lamp bead 13 and the fourth lamp bead 14 on the first wire 110 is cut off and a single-wire gap is formed, the high voltage of the first wire 110 cannot enter the fourth lamp bead 14, while the current flows from the third lamp bead 13 into the fourth lamp bead 14 as well as the fifth lamp bead 15 connected in parallel with the fourth lamp bead 14 via the second wire 120 Meanwhile, likewise, as a part of the second wire 120 between the fifth lamp bead 15 and the sixth lamp bead 16 is cut off, the high voltage of the second wire 120 cannot enter the sixth lamp bead 16, while the current flows from the fifth lamp bead 15 into the sixth lamp bead 16 via the first wire 110, such that the sixth lamp bead 16 is turned on. Through the above process, the connection of the lamp beads adjacent to the single-wire gaps is converted from parallel connection to series connection.

In the above, two wire ends at each single-wire gap are encapsulated and fixed with adjacent lamp beads by using glue. In combination with FIG. 1, the two wire ends at the first single-wire gap 131 are wire ends of a part of the first wire 110 between the third lamp bead 13 and the fourth lamp bead 14, wherein the two wire ends at the first single-wire gap 131 can be encapsulated and fixed with the fourth lamp bead 14 by glue, and of course, the two wire ends at the first single-wire gap 131 can also be encapsulated and fixed with the third lamp bead 13 by glue. Of course, as there are two wire ends at the first single-wire gap 131, it is also feasible that one wire end close to the third lamp bead 13 is encapsulated and fixed with the third lamp bead 13, and the other wire end close to the fourth lamp bead 14 is encapsulated and fixed with the fourth lamp bead 14. For the three encapsulating modes above, the encapsulation and fixation can be carried out according to the distances between the single-wire gap and the lamp beads close to the single-wire gap. For example, the wire end can be encapsulated and fixed with the lamp bead that is closer to the first single-wire gap 131, and if the distances between the wire end and the lamp beads are almost equal, the wire ends can be encapsulated and fixed with corresponding lamp beads respectively.

In combination with FIG. 1, likewise, the encapsulation and fixation mode at the second single-wire gap 132 is the same as that at the first single-wire gap 131, and the encapsulation and fixation can be carried out as well according to the distances between the single-wire gap and the lamp beads close to the single-wire gap. That is, the two wires ends at the second single-wire gap 132 are encapsulated and fixed with the fifth lamp bead 15 by glue, or the two wire ends at the second single-wire gap 132 are encapsulated and fixed with the sixth lamp bead 16 by glue, or it is also feasible that one wire end close to the fifth lamp bead 15 is encapsulated and fixed with the fifth lamp bead 15, and the other wire end close to the sixth lamp bead 16 is encapsulated and fixed with the sixth lamp bead 16.

In the above, the glue includes all types of encapsulation glue, for example, epoxy resin and silica gel. Besides, the wire ends can also be encapsulated and fixed with corresponding lamp beads by a PVC injection molding process.

To sum up, in the series-parallel structure lamp string provided in the present disclosure, the two wire ends at each single-wire gap can be encapsulated and fixed with adjacent lamp beads by glue, such that during encapsulation, the two output wire ends are invisible, which solves the problem that after a positive pole and a negative pole of the cut-off part are connected by an electric soldering iron, there is an extra useless wire, and only one wire is stressed at the place for series connection formed by cutting off lamp strings in parallel connection, so that insufficient soldering is also easy to occur in welding, and the phenomenon of wire breakage is quite easy to appear. Meanwhile, by encapsulating and fixing the two wire ends at each single-wire gap with the adjacent lamp beads, the problem that during packaging or assembling of the finished product, complete cut-off will result in easy scratching or scraping of hand or product at the place of the cut, and also will directly tear and damage the lamp beads. At the same time, when the glue is used for encapsulation and fixation, the glue material, which is not an electrically conductive material, will not affect normal operation of the series-parallel structure lamp string.

In the above, the plurality of lamp beads are encapsulated and fixed by glue with parts of the wires where the plurality of lamp beads are connected with the two wires. When there are two parallel wires (two wires), no matter whether the wires are cut off to form single-wire gaps or not cut off, the lamp beads are fixed with the two wires by glue. In the above, during manufacturing, the wires can be partially cut off, and then in the part that is not cut off, the two wires are fixed with the lamp beads connected thereto by glue, and the two wire ends in each cut-off part, i.e. the single-wire gap, are encapsulated and fixed with the adjacent lamp beads by glue, and since all the lamp beads are fixed by glue, the lamp beads can be protected.

In order to make the overall shape of the whole series-parallel structure lamp string consistent and not to influence the overall appearance, the glue at each lamp bead which is encapsulated and fixed by glue can be polished, so that the lamp beads that are encapsulated and fixed by glue have the same shape as lamp beads that are not encapsulated and fixed by glue (i.e., the lamp beads in parallel connection).

In order to protect safety of the two wires, in the embodiment of the present disclosure, a protection sleeve can be provided outside each of the two wires. In combination with FIG. 2, the first wire 110 includes a first protection sleeve 1101, and the second wire 120 includes a second protection sleeve 1201. In this way, the two wires can be protected against damage, and the service life of the series-parallel structure lamp string is improved.

In the above, in order not to affect the normal operation of the two wires, the material used for the protection sleeves is an insulation material. For example, the insulation material is PVC (polyvinyl chloride).

Besides, the first wire 110 includes a first protection sleeve 1101, the second wire 120 includes a second protection sleeve 1201, that is, when the two wires are placed into the protection sleeves, in order to make the overall shape of the whole series-parallel structure lamp string consistent and not to affect the overall beauty, two wire ends at each single-wire gap, the protection sleeves corresponding to the two respective wire ends at the single-wire gap and the lamp beads respectively adjacent to two wire ends at the single-wire gap can be encapsulated and fixed by glue.

In the above, the two wires are both single-core wires or multi-core wires. The series-parallel structure lamp string using the single-core wires are relatively hard on the whole, and can be applied to objects that cannot deform, or to surfaces of objects having a regular shape, for example, on buildings, wherein as buildings are relatively horizontally and vertically flat, the relatively hard series-parallel structure lamp string made of single-core wires can be used. The series-parallel structure lamp string using multi-core wires is softer on the whole, and can be applied to surfaces of objects having a relatively complex shape.

Optionally, each of the plurality of lamp beads includes two weld legs, wherein the two weld legs are connected with the two wires, and the two weld legs are configured to transmit current from the two wires to the lamp bead. As each of the plurality of lamp beads in the series-parallel structure lamp string is connected on the wires merely through two weld legs only, in order to save the cost, smaller lamp beads are manufactured, the lamp beads each having two weld legs can be used, and the current from the first wire 110 and the second wire 120 can be transmitted to the lamp beads via the two weld legs.

Optionally, all of the plurality of lamp beads mentioned in the above are LED lamps.

In combination with FIG. 2, the present disclosure provides a series-parallel structure lamp string system, including the series-parallel structure lamp string according to the above embodiment and a power supply controller 140, wherein the power supply controller 140 is configured to supply power to the series-parallel structure lamp string.

In the above, the power supply controller 140 is configured to output a DC current to the series-parallel structure lamp string.

In the series-parallel structure lamp string system provided in the present disclosure, a plurality of single-wire gaps can be provided on the wire, such that connections of the lamp beads adjacent to the single-wire gaps change from parallel connection to series connection, and meanwhile, two wire ends at each single-wire gap are encapsulated and fixed with the adjacent lamp beads by glue, such that the two wire ends at the single-wire gap are encapsulated together with the respective lamp beads, which alleviates the technical problem in the prior art that inconveniences are caused in terms of welding, assembling and so on when the lamps beads change from parallel connection to series connection.

In the series-parallel structure lamp string system provided in the present disclosure, a plurality of single-wire gaps can be provided on the wire, such that connections of the lamp beads adjacent to the single-wire gaps change from parallel connection to series connection, and meanwhile, two wire ends at each single-wire gap are encapsulated and fixed with the adjacent lamp beads by glue, such that the two wire ends at the single-wire gap are encapsulated together with the respective lamp beads, which alleviates the technical problem in the prior art that inconveniences are caused in terms of welding, assembling and so on when the lamps beads change from parallel connection to series connection.

Finally, it should be noted that the various embodiments above are merely used for illustrating the technical solutions of the present disclosure, rather than limiting the present disclosure; although the detailed description is made to the present disclosure with reference to the preceding embodiments, those ordinarily skilled in the art should understand that they still could modify the technical solutions disclosed in various preceding embodiments, or make equivalent substitutions to some or all of the technical features therein; and these modifications or substitutions do not make corresponding technical solutions essentially depart from the scope of the technical solutions of various embodiments of the present disclosure.

What is claimed is:

1. A series-parallel structure lamp string, comprising: two wires and a plurality of lamp beads, wherein the plurality of lamp beads are connected in parallel on the two wires, one or more single-wire gaps are formed on each of the two wires, and the lamp beads at two sides of each single-wire gap are connected with the two wires in such a manner that positive poles and negative poles of lamp beads at one side are opposite to positive poles and negative poles of lamp beads at the other side, such that connection relation between the lamp beads adjacent to each single-wire gap are converted from parallel connection to series connection; and
two wire ends at each single-wire gap are encapsulated and fixed with adjacent lamp beads by glue.

2. The series-parallel structure lamp string according to claim 1, wherein the plurality of lamp beads are encapsulated and fixed by glue with parts of the wires where the plurality of lamp beads are connected with the two wires.

3. The series-parallel structure lamp string according to claim 2, wherein a protection sleeve is provided outside each of the two wires.

4. The series-parallel structure lamp string according to claim 3, wherein a material used for making the protection sleeves is an insulation material.

5. The series-parallel structure lamp string according to claim 4, wherein each of the two wire ends of one wire at each single-wire gap is encapsulated and fixed, by glue, with a lamp bead on a side in parallel connection with and closest to the wire end.

6. The series-parallel structure lamp string according to claim 4, wherein each of the two wire ends of one wire at each single-wire gap is encapsulated and fixed, by glue, with a lamp bead on a side in series connection with and closest to the wire end.

7. The series-parallel structure lamp string according to claim 4, wherein each of the two wire ends of one wire at each single-wire gap is encapsulated and fixed, by glue, with lamp beads on a side in parallel connection and on a side in series connection with and closest to the wire end, respectively.

8. The series-parallel structure lamp string according to claim 5, wherein the insulation material is PVC.

9. The series-parallel structure lamp string according to claim 6, wherein the insulation material is PVC.

10. The series-parallel structure lamp string according to claim 7, wherein the insulation material is PVC.

11. The series-parallel structure lamp string according to claim 8, wherein the two wire ends at each single-wire gap, the protection sleeves corresponding to the two wire ends at the single-wire gap and the lamp beads respectively adjacent to two wire ends at the single-wire gap are encapsulated and fixed with each other by glue.

12. The series-parallel structure lamp string according to claim 9, wherein two wire ends at the single-wire gap, the protection sleeves corresponding to the two wire ends at the single-wire gap and the lamp beads respectively adjacent to two wire ends at the single-wire gap are encapsulated and fixed by glue.

13. The series-parallel structure lamp string according to claim 10, wherein two wire ends at each single-wire gap, the protection sleeves corresponding to the two wire ends at the single-wire gap and the lamp beads respectively adjacent to two wire ends at the single-wire gap are encapsulated and fixed with each other by glue.

14. The series-parallel structure lamp string according to claim 1, wherein the two wires are both single-core wires or multi-core wires.

15. The series-parallel structure lamp string according to claim 1, wherein each of the plurality of lamp beads comprises two weld legs, the two weld legs are connected with the two wires, and the two weld legs are configured to transmit current from the two wires to the lamp bead.

16. The series-parallel structure lamp string according to claim 5, wherein each of the plurality of lamp beads comprises two weld legs, the two weld legs are connected with the two wires, and the two weld legs are configured to transmit current from the two wires to the lamp bead.

17. The series-parallel structure lamp string according to claim 6, wherein each of the plurality of lamp beads comprises two weld legs, the two weld legs are connected with the two wires, and the two weld legs are configured to transmit current from the two wires to the lamp bead.

18. The series-parallel structure lamp string according to claim 7, wherein each of the plurality of lamp beads comprises two weld legs, the two weld legs are connected with the two wires, and the two weld legs are configured to transmit current from the two wires to the lamp bead.

19. The series-parallel structure lamp string according to claim 1, wherein each of the plurality of lamp beads is a LED lamp.

20. A series-parallel structure lamp string system, comprising the series-parallel structure lamp string according to claim 1 and a power supply controller configured to supply power to the series-parallel structure lamp string.
